(19) United States
(12) Patent Application Publication
(10) Pub. No.: US 2026/0285328 A1
(43) Pub. Date: Sep. 24, 2026

(54) STATISTICAL METHOD FOR COMPUTING ADAPTIVE CRUISE CONTROL (ACC) CONSTRAINT VIOLATIONS USING MULTIMODAL PREDICTIONS

(71) Applicant: Torc Robotics, Inc., Blacksburg, VA (US)

(72) Inventors: Savio Pereira, Austin, TX (US); Akshay Pai Raikar, Austin, TX (US)

(21) Appl. No.: 19/085,237

(22) Filed: Mar. 20, 2025

(51) Int. Cl. B60W 50/00; B60W 30/14; B60W 60/00

(52) U.S. Cl. CPC B60W 50/0098; B60W 30/14; B60W 60/0011; B60W 60/0027

(57) ABSTRACT

An autonomy computing system includes at least one memory configured to store machine executable instructions, and at least one processor coupled to the at least one memory and configured to execute the machine executable instructions to configure the at least one processor to: identify, based upon perception sensor data of a plurality of perception sensors, a plurality of actors in an environment of an autonomous vehicle comprising the autonomy computing system; generate a plurality of anticipated trajectories for an actor of the plurality of actors; generate a respective probability and a respective violation function value for each anticipated trajectory of the plurality of anticipated trajectories; and based upon the respective probability and the respective violation function value for each anticipated trajectory of the plurality of anticipated trajectories, compute a statistical violation value for an automatic cruise control constraint for the autonomous vehicle.

### TECHNICAL FIELD

The field of the disclosure relates to autonomous vehicles and, more specifically, a statistical method for computing adaptive cruise control (ACC) constraint violations using multimodal predictions.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning (or behaviors and motion planning (BMP)) technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

The BMP technologies is a component of a Virtual Driver (VD) stack and responsible for generating safe and comfortable trajectories for the autonomous vehicle to follow. The BMP component consumes information from upstream components associated with perception, actor prediction, and mapping, and generate a trajectory information for the autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system including at least one memory configured to store machine executable instructions, and at least one processor coupled to the at least one memory and configured to execute the machine executable instructions is disclosed. The machine executable instructions configure the at least one processor to: identify, based upon perception sensor data of a plurality of perception sensors, a plurality of actors in an environment of an autonomous vehicle comprising the autonomy computing system; generate a plurality of anticipated trajectories for an actor of the plurality of actors; generate a respective probability and a respective violation function value for each anticipated trajectory of the plurality of anticipated trajectories; and based upon the respective probability and the respective violation function value for each anticipated trajectory of the plurality of anticipated trajectories, compute a statistical violation value for an automatic cruise control constraint for the autonomous vehicle.

In another aspect, a computer-implemented method is disclosed. The computer-implemented method includes (i) identifying, based upon perception sensor data of a plurality of perception sensors, a plurality of actors in an environment of an autonomous vehicle; (ii) generating a plurality of anticipated trajectories for an actor of the plurality of actors; (iii) generating a respective probability and a respective violation function value for each anticipated trajectory of the plurality of anticipated trajectories; and (iv) based upon the respective probability and the respective violation function value for each anticipated trajectory of the plurality of anticipated trajectories, computing a statistical violation value for an adaptive cruise control constraint for the autonomous vehicle.

In yet another aspect, an autonomous vehicle including a plurality of perception sensors, at least one memory configured to store machine executable instructions, and at least one processor communicatively coupled with the at least one memory is disclosed. The at least one processor is configured to execute the machine executable instructions to configure the at least one processor to: identify, based upon perception sensor data of the plurality of perception sensors, a plurality of actors in an environment of the autonomous vehicle; generate a plurality of anticipated trajectories for an actor of the plurality of actors; generate a respective probability and a respective violation function value for each anticipated trajectory of the plurality of anticipated trajectories; and based upon the respective probability and the respective violation function value for each anticipated trajectory of the plurality of anticipated trajectories, compute a statistical violation value for an adaptive cruise control constraint for the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an example illustration of a plurality of predicted trajectories for an actor in vicinity of an autonomous vehicle on the road; and

FIG. 5 is a flow-chart of an example method of computing adaptive cruise control (ACC) constraint violations using multimodal predictions.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

State space of an autonomous vehicle: State space of an autonomous vehicle is a representation of the autonomous vehicle's position, velocity, and heading in a three-dimensional (3D) space. State space models are used to estimate the vehicle's position and plan its path.

Candidate trajectory: Within the BMP technologies, a candidate trajectory is defined as a sequence of waypoints over a specified time horizon (typically 12 to 15 seconds) starting from the autonomous vehicle's current location. Each waypoint includes a timestamp and information about the planned pose, curvature, velocity, and acceleration of the autonomous vehicle at that time. Generally, the waypoints are uniformly spaced apart in time. By way of an example, typical spacing in time between two waypoints may be 0.05 seconds.

Autonomous vehicle polygon: An autonomous vehicle polygon may also be referenced herein as a self-driving truck (SDT) polygon. At each waypoint along the candidate trajectory, the autonomous vehicle or SDT is represented by a 2D polygon. The 2D polygon may be the convex hull encompassing the geometry of the SDT or autonomous vehicle. The convex hull is further inflated by a configurable safety margin to ensure the SDT or autonomous vehicle maintains a safety buffer distance from other actors (or objects or vehicles) in the environment of the autonomous vehicle or SDT.

Actors and predicted trajectories: Actors in the present disclosure refer to moving objects in the vicinity of the autonomous vehicle or SDT. For each actor, an actor prediction component estimates a predicted future trajectory. The predicted trajectory includes a sequence of waypoints over a specified time horizon (typically 12 to 15 seconds) starting from the actor's current location. Each waypoint consists of a timestamp and information about the predicted pose and velocity of the actor at that time. The waypoints are uniformly spaced apart in time, for example, 0.05 seconds. Further, at each waypoint along the candidate trajectory, the actor is generally represented by a 2D polygon, as described herein, for an autonomous vehicle polygon.

As described herein, the BMP technologies is a component of a Virtual Driver (VD) stack and generates safe and comfortable trajectories for the autonomous vehicle to follow. The BMP technologies consume information from upstream components associated with perception, actor prediction, and mapping technologies to generate a trajectory information for the autonomous vehicle. Generally, safety and comfort of the planned trajectory are achieved by imposing constraints on the generated trajectory within the BMP component.

Safety and comfort of the planned trajectory are achieved by imposing constraints on the generated trajectory within the Motion Planning (MP) component. The MP component explores different trajectories in the state space of an autonomous vehicle, evaluates each of the trajectories based on the imposed constraints and then selects the trajectory that has the least constraint violations. Evaluation of each of the trajectories involves computing which of the constraints are violated by the trajectory and to what extent.

One of these constraints that is referenced herein as an adaptive cruise control (ACC) constraint is related to the ACC behavior of the autonomous vehicle (or the self-driving truck (SDT)). The ACC constraint penalizes a planned trajectory that takes the autonomous vehicle too close to the predicted trajectory of a lead vehicle ahead of, or in front of, the autonomous vehicle.

Typically, the Actor Prediction component outputs multiple possible future trajectories for a single actor in the environment of the autonomous vehicle. The single actor in the environment of the autonomous vehicle may be referenced herein as an Other Motor Vehicle (OMV). A probability may be computed and assigned to each possible future trajectory. However, one of the challenges within the MP component is to determine how to account for multiple probabilistic predicted trajectories when computing ACC constraint violations. Various embodiments described herein provide a novel statistical moment-based method for computing a statistical constraint violation for a planned trajectory that considers multiple predictions and their associated probabilities.

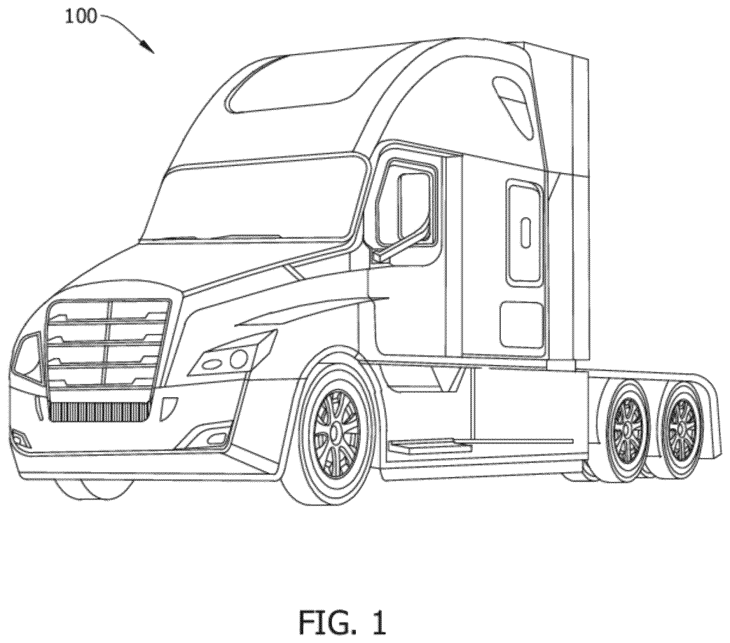

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

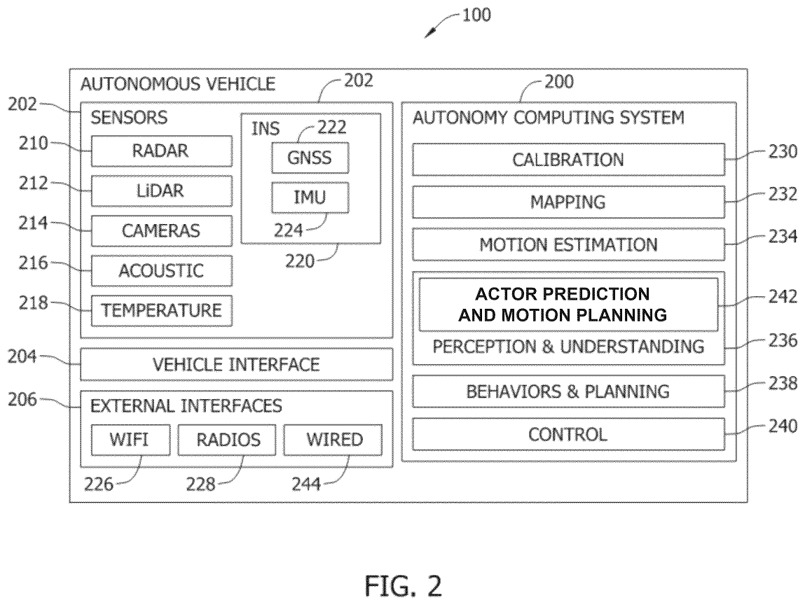

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

Cameras 214 may have temperature sensors 218 (e.g., one or more of negative temperature coefficient (NTC) thermistors, resistance temperature detectors (RTDs), thermocouples, or semiconductor-based integrated (IC) sensors) positioned on an external surface, or an internal surface, or both, to measure temperature on a camera lens surface of each of cameras 214. Additionally, temperature sensors 218 may be positioned on other areas of the autonomous vehicle 100, e.g., to measure ambient temperature.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an actor prediction and motion planning module 242. The actor prediction and motion planning module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The actor prediction and motion planning module 242 is configured to efficiently and robustly check whether a candidate trajectory violates any of the constraints, and in particular, the ACC constraint, as described in detail below.

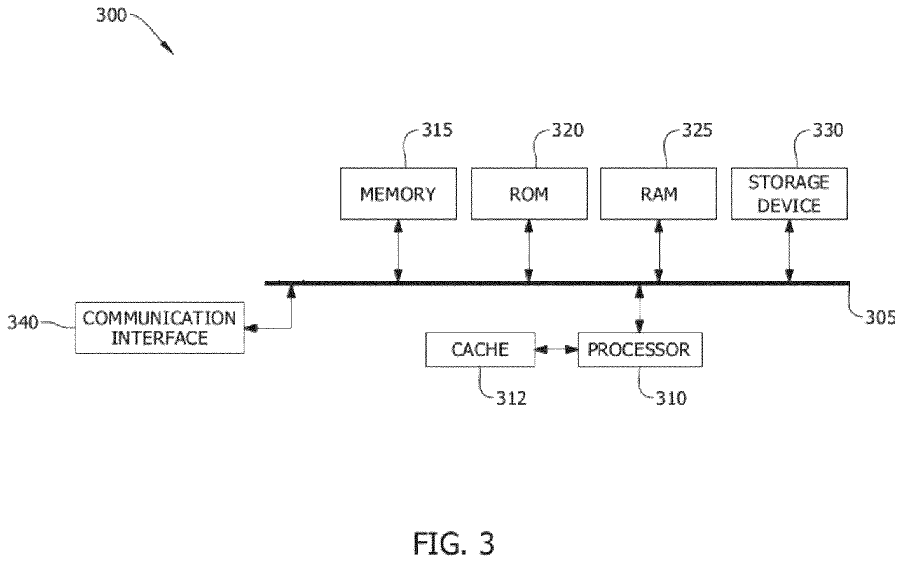

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

As described herein, multiples probabilistic predictions are generated by the Actor Prediction and Motion Planning component 242 (shown in FIG. 2). A single prediction contains a sequence of predicted waypoints in chronological order and an associated probability for that prediction. Each waypoint includes a timestamp and information about the predicted pose and velocity of the actor or OMV at that time. Further, a single prediction may be described herein as tₒₘᵥ. Within a set of multiple predictions, the i^{th} prediction may be denoted as

$${t}_{omv}^{i} ,$$

and its associated probability may be denoted by pⁱ.

A candidate planned trajectory for the autonomous vehicle may be generated by the behaviors and motion planning component 238. The candidate planned trajectory is characterized using a sequence of waypoints over a specified time horizon (typically 12 to 15 seconds) starting from the autonomous vehicle's current location. Each waypoint consists of a timestamp and information about the planned pose, curvature, velocity, and acceleration of the autonomous vehicle. In the present disclosure, a candidate planned trajectory for the autonomous vehicle may be denoted as t_{sdt}.

In some examples, a deterministic function ƒ( ) that takes as an input a given prediction of OMV, and a candidate planned trajectory for the autonomous vehicle, and outputs or computes the amount by which the candidate planned trajectory violates the ACC constraints for that OMV. The deterministic function (or constraint violation function) ƒ( ) may be used to generate

$$v = f ( {t}_{sdt ,} {t}_{omv}^{i} ) ,$$

where v corresponds with a violation value.

In some examples, the deterministic function may loop through each waypoint in the autonomous vehicle's candidate trajectory. For each waypoint in the autonomous vehicle's candidate trajectory, the nearest OMV waypoint ahead of a waypoint in the autonomous vehicle's candidate trajectory at that time is computed, and a longitudinal distance between the autonomous vehicle waypoint and the closest OMV waypoint is computed. If the longitudinal distance is less than a buffer distance, then the difference is added to the violation value. An example pseudo code for the violation function is as below.

```
  violation = 0.0
  for sdt_waypoint in sdt_trajectory:
    closest_omv_waypont = find_closest_lead_omv_waypoint
(sdt_waypoint)
    longitudinal_distance = find_longitudinal_distance
(sdt_waypoint, closest_omv_waypoint)
    if (longitudinal_distance < DESIRED_BUFFER_DISTANCE)
      violation += DESIRED_BUFFER_DISTANCE −
longitudinal_distance
```

Accordingly, computing the ACC constraint violations as described herein uses an expected value (or a first moment) of the constraint violation function, and scales the expected value of the constraint violation by the inverse of its variance (or a second moment). Further, a statistical violation (sv) for a given planned candidate trajectory may be computed as follows:

$${v}^{i} = f ( {t}_{sdt} , {t}_{omv}^{i} )$$

$$E [ v ] = {\sum }_{i = 1}^{n} {p}^{i} f ( {t}_{sdt} , {t}_{omv}^{i} )$$

$$Var [ v ] = E [ {v}^{2} ] - {\{ E [ v ] \}}^{2}$$

$$sv = \frac{E [ v ]}{Var [ v ]}$$

As described herein, the expected value of the violation function is chosen since it is a measure of its average violation over the predicted distribution. Further, the computed or chosen expected value of the violation function is augmented by scaling it with the inverse of a variance of a distribution. The variance of the distribution is an indicator of the spread of the distribution and thus an inverse measure for the confidence in the distribution. Statistical violation measure is generally high when both the average violation and the confidence in the distribution is high. The high value of the statistical violation measure occurs if the expected value is high, and the variance is low. The high confidence (or a low variance) may boost the expected value. Conversely, a lower confidence (or a higher variance) may discount the expected value of the violation.

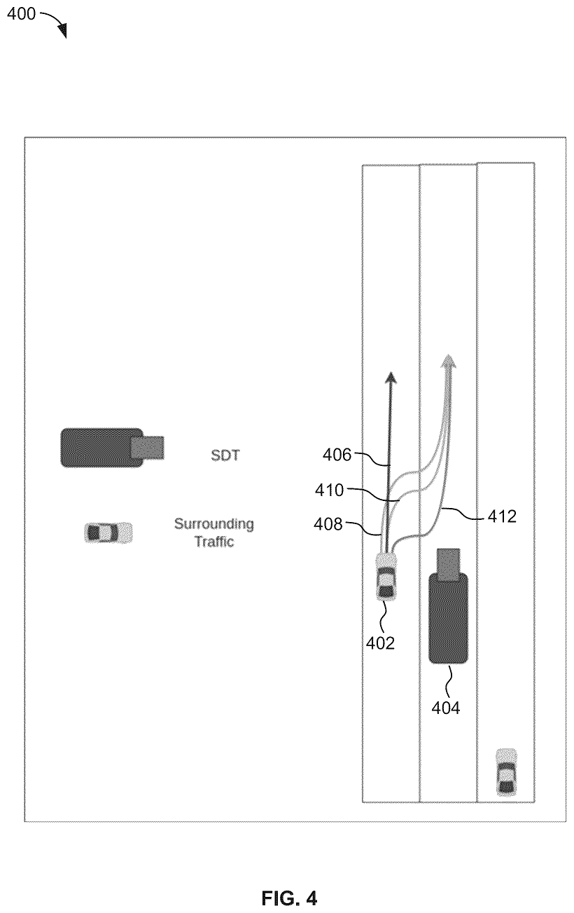

FIG. 4 is an example illustration 400 of a plurality of predicted trajectories for an actor 402 in vicinity of an autonomous vehicle 404 on the road. The plurality of predicted trajectories for the actor 402 includes trajectories 406, 408, 410, and 412. In FIG. 4, the autonomous vehicle 404 is in the right lane, and the actor 402 is in an adjacent left lane. For the actor 402, multiple probable future predictions are predicted along with their respective probability. Given a candidate planned trajectory for the autonomous vehicle 404, a violation value is computed for each prediction for the actor 402 using a function ƒ( ). Table 1 lists some hypothetical violation values for each prediction for the actor 402.

TABLE 1
Example violation values

| | | Violation function | Probability |
|---|---|---|---|
| Predicted Trajectory | Color | (vⁱ) | (pⁱ) |
| Stay in-current lane | Blue | 0.0 | 0.25 |
| Cut-in to Autonomous | Yellow | 3.0 | 0.50 |
| Vehicle's Lane slowly | | | |
| Cut-in to Autonomous | Green | 5.0 | 0.15 |
| Vehicle's Lane slightly faster | | | |
| Cut-in to Autonomous | Red | 9.0 | 0.10 |
| Vehicle's Lane aggressively | | | |

In some examples, based on the values in Table 1, the statistical violation (sv) may be computed as follows:

$$E [ v ] = \sum {v}^{i} \cdot {p}^{i} = 0.25 \cdot 0. + 0.5 \cdot 3. + 0.15 \cdot 5. + 0.1 \cdot 9. = 3.15$$

$$E [ {v}^{2} ] = \sum {v}^{i} \cdot {( {p}^{i} )}^{2} = 0.25 \cdot {0.}^{2} + 0.5 \cdot {3.}^{2} + 0.15 \cdot {5.}^{2} + 0.1 \cdot {9.}^{2} = 16.35$$

$$Var [ v ] = E [ {v}^{2} ] - {\{ E [ v ] \}}^{2} = 16.35 - {3.15}^{2} = 6.4275$$

$$sv = \frac{E [ v ]}{Var [ v ]} = \frac{3.15}{6.4275} = 0.49$$

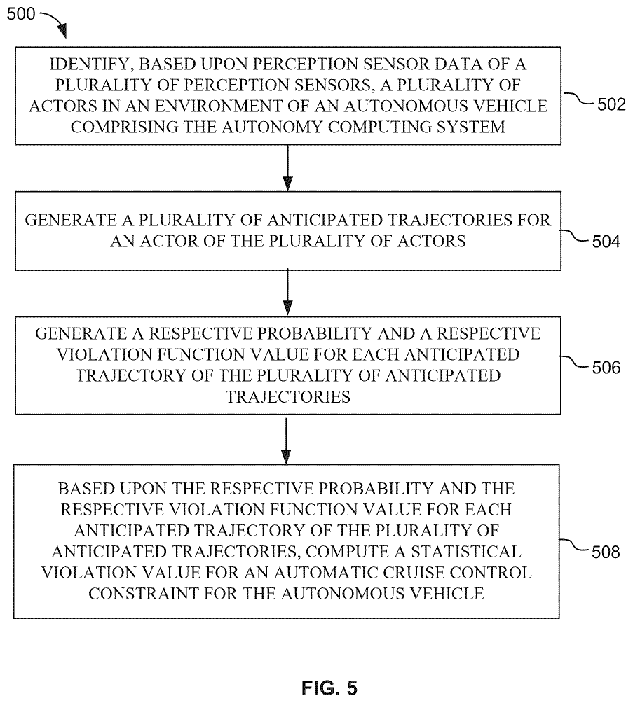

FIG. 5 is a flow-chart of an example method of computing ACC constraint violations using multimodal predictions. The method may be performed by an autonomy computing system (shown in FIG. 2) or by a computing system (shown in FIG. 3, which may be an application server). The method includes identifying 502 a plurality of actors in an environment of an autonomous vehicle. The plurality of actors in the environment of the autonomous vehicle is determined based upon perception sensor data of a plurality of perception sensors.

The method includes generating 504 a plurality of anticipated trajectories for an actor of the plurality of actor. In other words, all possible maneuver that the actor may perform are considered. Example of possible maneuver may include slow down and drive in the same lane, continue driving at the same speed in the same lane, change lane, etc. Further, the method includes displaying the autonomous vehicle or an actor of the plurality of actors as an inflated polygon. Each anticipated trajectory of the plurality of anticipated trajectories is generated for a predetermined time duration value such as 15 seconds.

Additionally, each anticipated trajectory of the plurality of anticipated trajectories includes a plurality of waypoints spaced apart in time by a specific time duration such as 0.05 seconds. Additionally, for each anticipated trajectory of the plurality of anticipated trajectories, a waypoint of the actor of the plurality of actors ahead of the autonomous vehicle is determined, and a longitudinal distance from the autonomous vehicle for the waypoint of the actor is computed. Based upon the longitudinal distance being less than a predetermined buffer distance, the waypoint is added in a list for generating the respective violation function value, as described herein.

The method includes generating 506 a respective probability and a respective violation function value for each anticipated trajectory of the plurality of anticipated trajectories as described herein, and based upon the respective probability and the respective violation function value for each anticipated trajectory of the plurality of anticipated trajectories, computing 508 a statistical violation value for an automatic cruise control constraint for the autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system comprising:
at least one memory configured to store machine executable instructions; and
at least one processor coupled to the at least one memory and configured to execute the machine executable instructions to configure the at least one processor to:
identify, based upon perception sensor data of a plurality of perception sensors, a plurality of actors in an environment of an autonomous vehicle comprising the autonomy computing system;
generate a plurality of anticipated trajectories for an actor of the plurality of actors;
generate a respective probability and a respective violation function value for each anticipated trajectory of the plurality of anticipated trajectories; and
based upon the respective probability and the respective violation function value for each anticipated trajectory of the plurality of anticipated trajectories, compute a statistical violation value for an automatic cruise control constraint for the autonomous vehicle.

2. The autonomy computing system of claim 1, wherein the at least one processor is further configured to execute the machine executable instructions to configure the at least one processor to display the autonomous vehicle or an actor of the plurality of actors as an inflated polygon.

3. The autonomy computing system of claim 1, wherein each anticipated trajectory of the plurality of anticipated trajectories is generated for a predetermined time duration value.

4. The autonomy computing system of claim 3, wherein the predetermined time duration value is 15 seconds.

5. The autonomy computing system of claim 3, wherein each anticipated trajectory of the plurality of anticipated trajectories includes a plurality of waypoints spaced apart in time by a specific time duration.

6. The autonomy computing system of claim 5, wherein the specific time duration is 0.05 seconds.

7. The autonomy computing system of claim 5, wherein the at least one processor is further configured to execute the machine executable instructions to configure the at least one processor to:
for each anticipated trajectory of the plurality of anticipated trajectories,
determine a waypoint of the actor of the plurality of actors ahead of the autonomous vehicle,
compute a longitudinal distance from the autonomous vehicle for the waypoint of the actor, and
based upon the longitudinal distance being less than a predetermined buffer distance, add the waypoint in a list for generating the respective violation function value.

8. A computer-implemented method comprising:
identifying, based upon perception sensor data of a plurality of perception sensors, a plurality of actors in an environment of an autonomous vehicle;
generating a plurality of anticipated trajectories for an actor of the plurality of actors;
generating a respective probability and a respective violation function value for each anticipated trajectory of the plurality of anticipated trajectories; and
based upon the respective probability and the respective violation function value for each anticipated trajectory of the plurality of anticipated trajectories, computing a statistical violation value for an automatic cruise control constraint for the autonomous vehicle.

9. The computer-implemented method of claim 8, further comprising displaying the autonomous vehicle or an actor of the plurality of actors as an inflated polygon.

10. The computer-implemented method of claim 8, further comprising generating each anticipated trajectory of the plurality of anticipated trajectories for a predetermined time duration value.

11. The computer-implemented method of claim 10, wherein the predetermined time duration value is 15 seconds.

12. The computer-implemented method of claim 10, wherein each anticipated trajectory of the plurality of anticipated trajectories includes a plurality of waypoints spaced apart in time by a specific time duration.

13. The computer-implemented method of claim 12, wherein the specific time duration is 0.05 seconds.

14. The computer-implemented method of claim 12, further comprising:
for each anticipated trajectory of the plurality of anticipated trajectories,
determining a waypoint of the actor of the plurality of actors ahead of the autonomous vehicle,
computing a longitudinal distance from the autonomous vehicle for the waypoint of the actor, and
based upon the longitudinal distance being less than a predetermined buffer distance, adding the waypoint in a list for generating the respective violation function value.

15. An autonomous vehicle comprising:
a plurality of perception sensors;
at least one memory configured to store machine executable instructions; and
at least one processor coupled to the at least one memory and configured to execute the machine executable instructions to configure the at least one processor to:
identify, based upon perception sensor data of the plurality of perception sensors, a plurality of actors in an environment of the autonomous vehicle;
generate a plurality of anticipated trajectories for an actor of the plurality of actors;
generate a respective probability and a respective violation function value for each anticipated trajectory of the plurality of anticipated trajectories; and
based upon the respective probability and the respective violation function value for each anticipated trajectory of the plurality of anticipated trajectories, compute a statistical violation value for an automatic cruise control constraint for the autonomous vehicle.

16. The autonomous vehicle of claim 15, wherein the at least one processor is further configured to execute the machine executable instructions to configure the at least one processor to display the autonomous vehicle or an actor of the plurality of actors as an inflated polygon.

17. The autonomous vehicle of claim 15, wherein each anticipated trajectory of the plurality of anticipated trajectories is generated for a predetermined time duration value, wherein the predetermined time duration value is 15 seconds.

18. The autonomous vehicle of claim 17, wherein each anticipated trajectory of the plurality of anticipated trajectories includes a plurality of waypoints spaced apart in time by a specific time duration.

19. The autonomous vehicle of claim 18, wherein the specific time duration is 0.05 seconds.

20. The autonomous vehicle of claim 18, wherein the at least one processor is further configured to execute the machine executable instructions to configure the at least one processor to:
for each anticipated trajectory of the plurality of anticipated trajectories,
determine a waypoint of the actor of the plurality of actors ahead of the autonomous vehicle,
compute a longitudinal distance from the autonomous vehicle for the waypoint of the actor, and
based upon the longitudinal distance being less than a predetermined buffer distance, add the waypoint in a list for generating the respective violation function value.
